(19) United States
(12) Patent Application Publication
(10) Pub. No.: US 2023/0152819 A1
(43) Pub. Date: May 18, 2023

(54) AUTONOMOUS MOBILE ROBOT WITH ENHANCED SENSING AND REPORTING OF OBSTACLES

(71) Applicants: Futaijing Precision Electronics (Yantai) Co., Ltd., Yantai (CN); HON HAI PRECISION INDUSTRY CO., LTD., New Taipei (TW)

(72) Inventors: HSIAO-LUN CHEN, New Taipei (TW); CHUN-YUAN CHIEN, New Taipei (TW)

(21) Appl. No.: 17/686,739

(22) Filed: Mar. 4, 2022

(30) Foreign Application Priority Data
Nov. 17, 2021 (CN) 202111363885.8

(51) Int. Cl. G05D 1/02; G01S 17/931; G01S 7/481

(52) U.S. Cl. CPC G05D 1/024; G05D 1/0242; G05D 1/0212; G01S 17/931; G01S 7/4815

(57) ABSTRACT

An autonomous mobile robot with enhanced reliability in sensing and reporting obstacles and reduced signal distortion between obstacle sensors and processor comprises a data processor, a light detection and ranging module, a plurality of proximity sensors, and a multiplexer. The light detection and ranging module is coupled to the data processor and transmits first sensing signals to the data processor. The proximity sensors transmit second sensing signals to the data processor through the multiplexer, and the data processor performs path planning based on the first sensing signals and the second sensing signals.

### TECHNICAL FIELD

The subject matter herein generally relates to robots, in particular to autonomous mobile robots.

### BACKGROUND

Autonomous mobile robots brings a lot of benefits to homes and industry. An autonomous mobile robot system involves signal acquisition, signal processing, and signal transmission. Signal output by a sensor of the autonomous mobile robot may be weak, and often becomes distorted during a signal transmission process.

### BRIEF DESCRIPTION OF THE DRAWINGS

Implementations of the present technology will now be described, by way of example only, with reference to the attached figures.

FIG. 1 is a diagram of an embodiment of an autonomous mobile robot according to the present disclosure.

FIG. 2 is a diagram of an embodiment of an obstacle detection system of the autonomous mobile robot of FIG. 1.

FIG. 3 is a circuit diagram of an embodiment of an obstacle detection system of the autonomous mobile robot of FIG. 1.

FIG. 4 is a layout structure diagram of a proximity sensor of the autonomous mobile robot of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

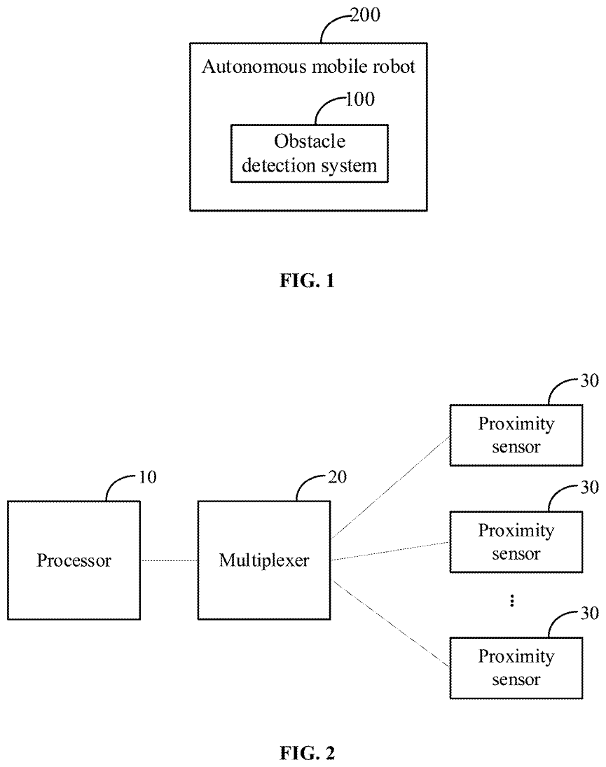

FIG. 1 illustrates a diagram of an obstacle detection system 100 in one embodiment of the present application. The obstacle detection system 100 can be operated in an autonomous mobile robot (AMR) 200. The AMR 200 can detect obstacles and perform path planning based on the obstacle detection system 100.

Referring to FIG. 2, the obstacle detection system 100 can comprises a processor 10, a multiplexer 20, and a plurality of proximity sensors 30. Each proximity sensor 30 transmits first sensing signals to the processor 10 through the multiplexer 20. The multiplexer 20 can be arranged on a first printed circuit board (PCB), and the plurality of proximity sensors 30 can be arranged on multiple second PCBs.

In this embodiment, by setting multiplexer 20 between the processor 10 and the proximity sensors 30, the first sensing signals output by the proximity sensors 30 can be enhanced. The processor 10 can switch communication paths of the multiplexer 20 to achieve communication through one communication port of the processor 10 receiving the first sensing signals of multiple proximity sensors 30, communication port resources of the processor 10 can be saved.

In one embodiment, the processor 10 may be a central processing unit (CPU), an application specific integrated circuit (ASIC), a microcontroller unit (MCU), a single chip, etc. The multiplexer 20 may be a two-to-one multiplexer switch, an eight-to-one multiplexer switch, a sixteen-to-one multiplexer switch, etc. The proximity sensors 30 may be infrared sensors or other sensors that can sense distance.

In one embodiment, the AMR 200 can further comprise a light detection and ranging (LDR) module 40. The LDR module 40 is coupled to the processor 10 and transmits second sensing signals to the processor 10. The processor 10 can perform path planning based on the first sensing signals and the second sensing signals.

In one embodiment, the AMR 200 can obtain environment information through the LDR module 40, and build an environment map based on a simultaneous localization and mapping (SLAM) algorithm. The AMR 200 can perform autonomous navigation and path planning based on the environment map. For example, the environment information obtained by the LDR module 40 can be transmitted to the processor 10, and the processor 10 can execute the SLAM algorithm to build the environment map.

In one embodiment, the proximity sensors 30 can assist the LDR module 40 to detect obstacles, discover low-angle areas and blind areas that cannot be detected by the LDR module 40. An ability of the AMR 200 to detect local environment is enhanced and a safety is improved.

In one embodiment, the proximity sensors 30 can be arranged on an area with a radius greater than or equal to a preset value, and a center of the area is a laser emission point of the LDR module 40. The preset value can be defined according to an actual size or a layout structure of the AMR 200, for example, the preset value can be 10 cm.

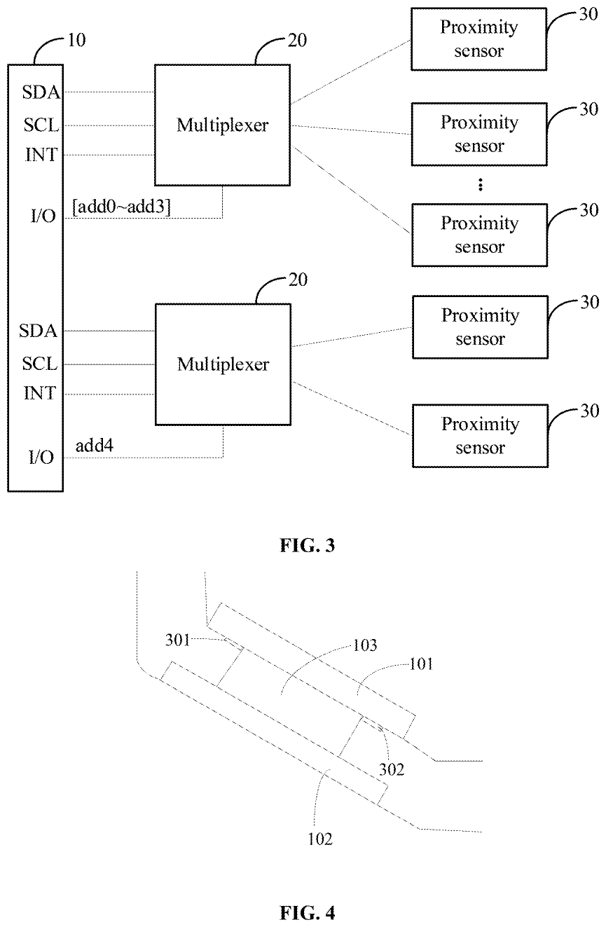

Referring to FIG. 3, the number of proximity sensors 30 is eighteen as an example, and two multiplexers 20 are arranged between the processor 10 and the eighteen proximity sensors 30. One multiplexer 20 is a two-to-one multiplexer switch, the other one multiplexer 20 is a sixteen-to-one multiplexer switch. The processor 10 can communicate with the two multiplexers 20 through two inter-integrated circuit (I2C) ports. Each of the two I2C ports can comprise three I2C communication pins, a serial data (SDA) pin, a serial clock (SCL) pin, and an interrupt (INT) pin. The multiplexer 20 can comprise an input terminal, an output terminal, and a control terminal. The input terminals of the multiplexer 20 are coupled to the proximity sensors 30. The control terminal of the multiplexer 20 is coupled to an input/output (I/O) pin of the processor 10, such as a general purpose input/output (GPIO) pin. The output terminal of the multiplexer 20 is coupled to the I2C communication pin of the processor 10. The processor 10 can switch the communication path of the multiplexer 20 through the control terminal and the I/O pin.

Referring to FIG. 3, if one multiplexer 20 is the sixteen-to-one multiplexer switch, the processor 10 can switch the communication path of the one multiplexer 20 through four I/O pins (for example, four I/O pins can be address bus pins add0, addl, add2, and add3 of the processor 10). If the other multiplexer 20 is the two-to-one multiplexer switch, the processor 10 can switch the communication path of the other one multiplexer 20 through one I/O pin (address bus pin add4 of the processor 10).

In one embodiment, in the AMR 200, by setting the multiplexer 20 to couple with the proximity sensors 30, the proximity sensors 30 share a section of I2C communication line, and thus a length of the total I2C communication line is reduced. A parasitic capacitance of the I2C communication line and likelihood of signal distortion are reduced, and a problem of signal slowdown is avoided by using the multiplexer 20.

In one embodiment, the shorter the communication line between the proximity sensors 30 and the multiplexer 20, the lower the likelihood of signal distortion.

In one embodiment, the proximity sensors 30 are arranged at corner areas of the AMR 200, to compensate for the low-angle areas and the blind areas that cannot be detected by the LDR module 40. The multiplexer 20 and the processor 10 may be arranged in a motherboard of the AMR 200. The eighteen proximity sensors 30 are arranged on multiple sub-circuit boards, and the first sensing signals of the eighteen proximity sensors 30 are transmitted to the multiplexer 20 through multiple signal lines. The higher the conductivity of the signal lines, the larger the parasitic capacitance, and the slower the signal climbing speed. Ultra-low dielectric coefficient wires are used to transmit the first sensing signals, to reduce the parasitic capacitance.

FIG. 4 illustrates a layout structure diagram of an embodiment of the proximity sensor 30 of the present application.

In one embodiment, the proximity sensor 30 is the infrared sensor. The proximity sensor 30 can be arranged on the second PCB 101. The proximity sensor 30 can comprise an infrared transmitter 301 and an infrared receiver 302. Infrared light of the infrared transmitter 301 can be transmitted through a transparency lens 102. A spacer 103 can be arranged between the infrared transmitter 301 and the infrared receiver 302. The spacer 103 can be configured to block light reflected by the transparency lens 102 and stop it entering into the infrared receiver 302, so light reflected by the translucent lens 102 can be reduced.

In one embodiment, the translucent lens 102 can also provide a basic protection of the proximity sensor 30, to protect the proximity sensor 30 from collision, splashing water, static electricity, etc. The translucent lens 102 may comprise a lens body, a first anti-reflection (AR) coating disposed on one surface of the lens body, and a second AR coating and an anti-fingerprint (AF) coating disposed on the other surface of the lens body. Surface reflectance of the translucent lens 10 is reduced and a vertical light transmittance can be increased by the inner AR coating and the outer AR coating (first and second AR coatings). The translucent lens 102 can be made of polycarbonate (PC) and polymethyl methacrylate (PMMA) composite material, which improves the light transmittance and coating strength of the translucent lens 102, reducing ageing caused by light source irradiation, and lower reflected noise.

In one embodiment, a material of the spacer 103 is rubber.

In one embodiment, in order to calibrate an obstacle detection accuracy of the proximity sensor 30, a first sensing noise of the proximity sensor 30 is measured when there is no obstacle on a black floor, and sensing signals of an obstacle on the black floor are detected, then the sensing signal of the obstacle on the black floor can be calibrated based on the first sensing noise. A second sensing noise of the proximity sensor 30 is measured when there is no obstacle on a white floor, and sensing signals of an obstacle on the white floor is detected, then the sensing signal of the obstacle on the white floor can be calibrated based on the second sensing noise. An activation ratio of the proximity sensor 30 can be calculated through return values of sensor existing or not existing in respect of obstacles. The calculated activation ratio of each proximity sensor 30 in the worst case can be recorded into the AMR 200, and the sensing accuracy of the proximity sensor 30 can be improved. In an actual operating environment, the floor may be different colors or slightly different colors, return values of each proximity sensor 30 may be checked for consistency. Each proximity sensor 30 can interact with a SLAM system of the AMR 200, to record floor noise of areas when the AMR 200 performs map building and/or positioning during there are/no obstacles around the AMR 200, to improve the sensing accuracy of the proximity sensors 30.

The exemplary embodiments shown and described above are only examples. Many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. An autonomous mobile robot (AMR) comprising:
a processor;
a light detection and ranging (LDR) module coupled to the processor, and transmitting first sensing signals to the processor;
a plurality of proximity sensors; and
a multiplexer;
wherein the plurality of proximity sensors transmits second sensing signals to the processor through the multiplexer; and the processor is configured to perform path planning based on the first sensing signals and the second sensing signals.

2. The AMR of claim 1, wherein the multiplexer is arranged on a first printed circuit board (PCB); the plurality of proximity sensors is arranged on multiple second PCBs; and the second sensing signals from the plurality of proximity sensors are transmitted to the multiplexer through multiple signal lines.

3. The AMR of claim 1, wherein the multiplexer comprises a control terminal, an input terminal, and an output terminal, the input terminal of the multiplexer is coupled to the plurality of proximity sensors, the control terminal and the output terminal of the multiplexer is coupled to the processor; and the processor switches communication paths of the multiplexer via the control terminal.

4. The AMR of claim 3, wherein the output terminal of the multiplexer is coupled to an inter integrated-circuit (I2C) communication pin of the processor.

5. The AMR of claim 1, wherein the plurality of proximity sensors are infrared sensors, and the processor is a microcontroller unit (MCU).

6. The AMR of claim 5, further comprising a transparency lens, wherein infrared light of the infrared sensors is transmitted through the transparency lens.

7. The AMR of claim 6, wherein each of the infrared sensors comprises an infrared transmitter and an infrared receiver; a spacer is arranged between the infrared transmitter and the infrared receiver, and the spacer is configured to block light reflected by the transparency lens entering into the infrared receiver.

8. The AMR of claim 7, wherein a material of the spacer is rubber.

9. The AMR of claim 6, wherein the transparency lens comprises a lens body, a first anti-reflection coating disposed on one surface of the lens body, and a second anti-reflection coating and an anti-fingerprint coating disposed on the other surface of the lens body.

10. The AMR of claim 5, wherein the plurality of proximity sensors is arranged on an area with a radius greater than or equal to a preset value, a center of the area is a laser emission point of the LDR module.

11. An autonomous mobile robot (AMR) comprising:
a processor;
a plurality of proximity sensors; and
a multiplexer;
wherein the plurality of proximity sensors transmits sensing signals to the processor through the multiplexer; and the processor is configured to perform path planning based on the sensing signals.
